(19) United States
(12) Patent Application Publication
(10) Pub. No.: US 2023/0335989 A1
(43) Pub. Date: Oct. 19, 2023

(54) WIND TURBINE LAYOUT METHOD AND DEVICE

(71) Applicant: BEIJING GOLDWIND SCIENCE & CREATION WINDPOWER EQUIPMENT CO., LTD., Beijing (CN)

(72) Inventors: Chuikuan ZENG, Beijing (CN); Congcong ZHANG, Beijing (CN); Xiaolong XU, Beijing (CN)

(21) Appl. No.: 18/341,671

(22) Filed: Jun. 26, 2023

Related U.S. Application Data
(63) Continuation-in-part of application No. 16/651,948, filed on Mar. 27, 2020.

(30) Foreign Application Priority Data
Mar. 29, 2018 (CN) 201810270878.5

(51) Int. Cl. H02J 3/00; G06Q 50/06; F03D 9/48

(52) U.S. Cl. CPC H02J 3/004; F03D 9/48; G06Q 50/06; F05B 2260/8211; H02J 2300/28

(57) ABSTRACT

A mesoscale data-based automatic wind turbine layout method and device. The method comprises: initially screening an input wind field region on the basis of input mesoscale wind map data by means of a wind speed limit value to obtain a first wind field region; re-screening the first wind field region on the basis of input terrain data by means of a slope limit value to obtain a second wind field region; and determining, by means of tabu search in which a target wind turbine count and the second wind field region are used as inputs, a wind turbine layout that optimizes an objective function, wherein the objective function is the sum of the annual energy production for wind turbine locations.

### CROSS-REFERENCE TO RELATED APPLICATIONS

The present application is a continuation-in-part of U.S. Application No. 16/651,948, which was filed on Mar. 27, 2020, which in turn is the U.S. National Phase of International Application No. PCT/CN2018/097352, titled “MESOSCALE DATA-BASED AUTOMATIC WIND TURBINE LAYOUT METHOD AND DEVICE”, filed on Jul. 27, 2018, which claims priority to Chinese Patent Application No. 201810270878.5, titled “MESOSCALE DATA-BASED AUTOMATIC WIND TURBINE LAYOUT METHOD AND DEVICE”, filed on Mar. 29, 2018, with the China National Intellectual Property Administration, both of which are incorporated herein by reference in their entirety.

### TECHNICAL FIELD

The present disclosure relates to the field of wind power generation technology, and in particular to a method and a device for automatically arranging a wind turbine based on mesoscale data.

### BACKGROUND

Wind energy, known for its cleanliness and cost-effectiveness, has been one of the main alternatives to fossil fuels. Compared with other traditional energy sources, wind energy has the advantages of abundant resources, sustainable development and economic competitiveness, and has developed rapidly in recent years. There has been a huge increase in wind farm capacity worldwide in recent years.

For a given wind farm, maximizing the captured energy is a constant goal. Although a better layout can improve the energy conversion efficiency and reduce the economic cost of wind farms, the output of wind energy is determined by the local wind speed distribution characteristics. The power generation of the wind turbine is limited by the wind speed, and it may be difficult to increase the power output.

Sitting of wind turbines is burdensome, in particular in respect of on-shore turbines. Geographical regions must be identified, which are appropriate in terms of wind conditions as well as in terms of aesthetic appearance and possible noise annoyances, and relevant public authorities must approve the erection of a wind turbine or a wind turbine farm in a certain region. Once a geographical region has been identified as a site for a wind turbine or a wind turbine farm, much effort is usually put into detailed siting to optimize power output of the wind turbine(s). Such optimization may include empirical or numerical wind flow determination in the geographical region of interest to determine wind climate, including average wind speed and pre-dominant wind directions. The wind speed at various locations within the region of interest may be translated into a potential power output of the wind turbine to be sited. Typically, the potential power output varies from location to location within the region. The exact position of a single wind turbine is often chosen to be that position, at which the potential power output is highest. Likewise, siting of wind farms typically aims at distributing the wind turbines to achieve a maximum power output.

It will be appreciated that much is done in terms of aerodynamic site optimization to ensure maximum power output. However, maintenance costs have hitherto been disregarded when siting wind turbines or wind turbine farms, in spite of the fact that maintenance, including component replacement, presents a significant cost item in wind turbine budgets. Hence, certain aspects of the present invention aim at taking maintenance parameters into consideration in a wind turbine siting computer system and method.

Other aspects of the present invention relate to visualization of wind turbines to be erected at a certain geographical location. Such visualization is relevant not only to provide an aesthetical comprehension of the visual impacts of a wind turbine or a wind turbine farm in a certain geographical area, but also to provide siting engineers with a technical comprehension, e.g. to allow engineers to spot inexpedient mutual positions of two wind turbines, such as positions in which a wake effect downstream of one wind turbine could cause undesirable turbulence at or near a second wind turbine. In other words, with the experience of skilled wind turbine siting engineers, an accurate visualization of a projected wind turbine or wind turbine farm may replace or at least reduce the need for expensive numerical computations and/or wind tunnel tests.

Using wind turbine automatic arrangement technology, automatic analysis of wind resource data and terrain data can be realized with consideration in the influence of dynamic factors such as wake, thereby realizing automatic arrangement of wind turbines. At present, based on a fully automatic wind turbine optimized arrangement solution, a design subject to minimal influence of wake can be obtained by adopting an appropriate wake model. In addition, when optimizing the wind turbine arrangement, besides considering the influence of wake, multi-objective optimization including factors such as project cost, investment income, and noise may also be considered. For example, the wind turbine automatic arrangement technology widely used in wind turbine industry may include commercial software such as Openwind and WindPro.

However, the conventional wind turbine automatic arrangement algorithm is based on fluid simulation and wind atlas data and is only applicable in a micro-siting stage, where the wind atlas data is obtained based on wind measurement data of a wind measurement tower. In a macro-siting stage, no existing algorithms or software are applicable.

Therefore, it is of great practical significance to provide a method and a device capable of realizing refined macro-siting.

### SUMMARY

A method and a device for arranging a wind turbine based on mesoscale data are provided according to the present disclosure.

According to an aspect of the present disclosure, a method for arranging a wind turbine based on mesoscale data is provided. The method includes: performing, based on inputted mesoscale wind atlas data, a first screening on an inputted wind field area by using a wind speed limit to obtain a first wind field area; performing, based on inputted terrain data, a second screening on the first wind field area by using a slope limit to obtain a second wind field area; and determining, by using a method of taboo search having a target number of wind turbines and the second wind field area as inputs, a wind turbine arrangement that renders an objective function optimal; validating the wind turbine arrangement by surveying suitable terrain and topography by a handhold surveying device, wherein the handhold surveying device has an antenna for receiving at least one wireless signal, where the objective function is a sum of annual power generations at wind turbine sites.

According to an aspect of the present disclosure, a device for automatically arranging a wind turbine based on mesoscale data is provided. The device includes: a preprocessing unit and a wind turbine arrangement optimization unit. The preprocessing unit is configured to perform, based on inputted mesoscale wind atlas data, a first screening on an inputted wind field area by using a wind speed limit to obtain a first wind field area, and perform, based on inputted terrain data, a second screening on the first wind field area by using a slope limit to obtain a second wind field area. The wind turbine arrangement optimization unit is configured to determine, by using a method of taboo search having a target number of wind turbines and the second wind field area as inputs, a wind turbine arrangement that renders an objective function optimal, where the objective function is a sum of annual power generations at wind turbine sites.

In another embodiment, a method comprises steps of obtaining, for each grid point, an annual average wind speed of each sector and a wind frequency corresponding to each sector based on an inputted mesoscale wind atlas data to perform a first screening on an inputted wind field area by using a wind speed limit to obtain a first wind field area; performing, based on an inputted terrain data, a second screening on the first wind field area by using a slope limit to obtain a second wind field area; determining, by using a method of taboo search having a target number of wind turbines and the second wind field area as inputs, a wind turbine arrangement that renders an objective function optimal; and validating the wind turbine arrangement by surveying suitable terrain and topography by a handhold surveying device, wherein the handhold surveying device has an antenna for receiving at least one wireless signal.

According to yet another embodiment, a method comprises steps of a first screening on an inputted wind field area by using a wind speed limit to obtain a first wind field area; a second screening on the first wind field area by using a slope limit to obtain a second wind field area; determining a wind turbine arrangement that renders an objective function optimal; and validating the wind turbine arrangement by surveying suitable terrain and topography by a handhold surveying device, wherein the handhold surveying device has an antenna for receiving at least one wireless signal.

According to an aspect of the present disclosure, a computer readable storage medium is provided. The computer readable storage medium has a program stored thereon, where the program includes instructions for performing the above operations for automatically arranging a wind turbine based on mesoscale data.

According to an aspect of the present disclosure, a computer is provided. The computer includes a readable medium with a computer program stored thereon, where the computer program includes instructions for performing the above operations for automatically arranging a wind turbine based on mesoscale data.

With the method and device for automatically arranging a wind turbine based on mesoscale data, non-optimal wind area can be excluded by setting a wind speed limit, thereby avoiding a large number of useless calculations (that is, improving the efficiency of the algorithm) and inaccurate results caused by too small wind speeds, and areas having a large slope which are not suitable for setting up wind turbines can also be excluded by setting a slope limit, thereby avoiding risky areas and reducing the amount of data for automatic optimizing of wind turbines. In addition, in the above method and device, with the annual power generation used as the objective function, the optimized global automatic arrangement of wind turbines is achieved in the macro-siting stage by using the method of taboo search. As the method of taboo search is more efficient than optimization methods such as genetic algorithms, quick response to service demands can be achieved, and wind turbine arrangement solutions can be generated instantly to effectively support technical applications.

### BRIEF DESCRIPTION OF THE DRAWINGS

Those skilled in the art will completely understand the present disclosure by the following detailed description of the exemplary embodiments of the present disclosure in conjunction with the accompanying drawings, where:

FIG. 1 is a general flow chart of a method for automatically arranging a wind turbine based on mesoscale data according to an exemplary embodiment of the present disclosure;

FIG. 2 is a flow chart showing a process of calculating an annual average wind speed at each grid point according to an exemplary embodiment of the present disclosure;

FIG. 3 is a schematic diagram of an elevation matrix used in performing a screening on mesoscale wind atlas data on which a first screening has been performed according to an exemplary embodiment of the present disclosure;

FIG. 4 is a flow chart of operations for determining a wind turbine arrangement by using a method of taboo search according to an exemplary embodiment of the present disclosure;

FIG. 5 is a block diagram of a device for automatically arranging a wind turbine based on mesoscale data according to an exemplary embodiment of the present disclosure; and

FIG. 6 is a block diagram of an exemplary computer system suitable for implementing the exemplary embodiments of the present disclosure.

### DETAILED DESCRIPTION OF THE EMBODIMENTS

Exemplary embodiments may take the form of an entire hardware embodiment, an entire software embodiment (including firmware, resident software, micro-code, etc.) or an embodiment combining software and hardware aspects that may all generally be referred to herein as a “circuit,” “module” or “system.” Furthermore, exemplary embodiments may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction performance system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireless, wireline, optical fiber cable, RF, etc.

Computer program code for carrying out operations of exemplary embodiments may be written in any combination of one or more programming languages, including an object oriented programming language such as Java, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

Exemplary embodiments are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In order to make those skilled in the art more aware of the stage in which the present disclosure is used in the wind turbine siting, a wind turbine macro-siting stage and a wind turbine micro-siting stage are explained in detail first. The wind turbine macro-siting stage and the wind turbine micro-siting stage are different wind turbine siting stages. The wind turbine macro-siting stage is also referred to as a wind farm siting stage. That is, by analyzing and comparing wind resources and other construction conditions at several wind farm sites in a large area, a construction site, development value, development strategy, and development steps of a wind farm are determined. The wind turbine micro-siting stage is a stage of selecting a specific location of a wind turbine, at which a wind measurement tower has been established and annual wind measurement data has been obtained. That is, with consideration in a large number of factors such as costs and benefits, a specific construction site of a wind turbine is optimized based on wind measurement tower information in the wind farm, the annual wind measurement data of the wind measurement tower, and multi-year data from local weather stations. With the present disclosure, a wind turbine arrangement can be quickly determined based on mesoscale data (that is, data with a lower precision than the data measured by the wind measurement tower) in the wind turbine macro-siting stage.

Hereinafter, exemplary embodiments of the present disclosure will be described in detail in conjunction with the drawings, where same reference numbers always represent the same components.

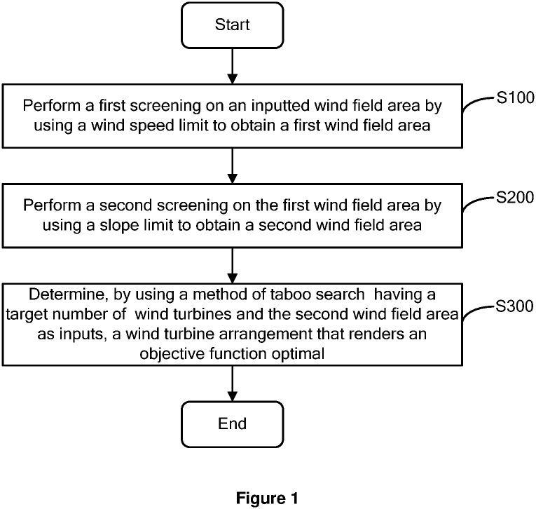

FIG. 1 is a general flow chart of a method for automatically arranging a wind turbine based on mesoscale data according to an exemplary embodiment of the present disclosure.

Referring to FIG. 1, in step S100, based on inputted mesoscale wind atlas data, a first screening is performed on an inputted wind field area by using a wind speed limit to obtain a first wind field area. The mesoscale wind atlas data is wind resource distribution data which is calculated by using a mesoscale numerical model. In an embodiment, the mesoscale wind atlas data is data of wind resources with typical grid precision at mesoscale level, which is calculated by using the mesoscale numerical model combined with wind measurement data. For example, the mesoscale data may be MERRA-2 (Modern-Era Retrospective analysis for Research and Applications, Version 2) data, that is, the re-analysis data from the global simulation and assimilation office of NASA (National Aeronautics and Space Administration). The mesoscale wind atlas data may include a shape parameter (k) and a scale parameter (a) of an annual Weilbull probability density distribution function for each sector (that is, each wind direction) of each grid point. Or, the mesoscale wind atlas data may include a shape parameter (k) and a scale parameter (a) of an annual Weilbull probability density distribution function at each grid point (that is, k and a of the annual Weilbull probability density distribution function at each grid point without considering the sector). The mesoscale wind atlas data may be inputted into the system in dat or wrg format.

In an embodiment, the performing a first screening on an inputted wind field area by using a wind speed limit to obtain a first wind field area includes: calculating an annual average wind speed at each grid point in the inputted wind field area based on the inputted mesoscale wind atlas data; and removing grid points at which an annual average wind speed is less than the wind speed limit from the inputted wind field area to obtain the first wind field area, that is, removing grid areas including the grid points with an annual average wind speed less than the wind speed limit from the inputted wind field area to obtain the first wind field area.

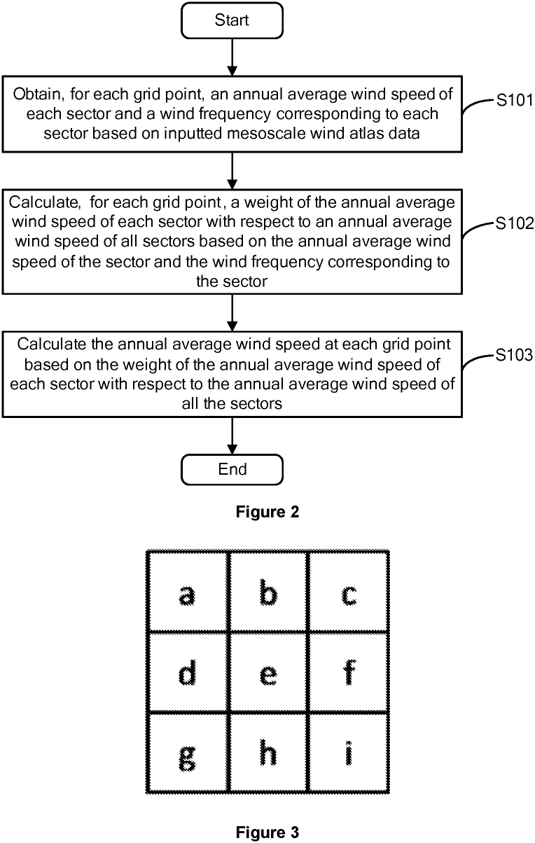

The process of calculating the annual average wind speed at each grid point is described in detail hereinafter with reference to FIG. 2.

FIG. 2 is a flow chart showing a process of calculating the annual average wind speed at each grid point according to an exemplary embodiment of the present disclosure. The grid point corresponds to a grid in a grid system, where the grid point may be one of four vertices of the corresponding grid or a point at a predetermined position in the corresponding grid. For a grid system corresponding to a mesoscale atlas, a length and a width of each grid may range from 100 m to 200 m, and the present disclosure is not limited thereto.

As shown in FIG. 2, in step S101, for each grid point, an annual average wind speed of each sector and a wind frequency corresponding to each sector are obtained based on the inputted mesoscale wind atlas data, where the sector indicates a wind direction. In an embodiment, an annual average wind speed

$${\text{V}}_{\text{ave}}^{\text{i}}$$

of an i^{th} sector can be calculated by using the following equation (1):

$${\text{V}}_{\text{ave}}^{\text{i}} = {\text{a}}_{\text{i}} \text{Γ} \left(1 + \frac{1}{{\text{k}}_{\text{i}}}\right) \qquad \text{(1)}$$

where Γ() represents gamma function, and aᵢ and kᵢ represent a scale parameter and a shape parameter of a Weilbull probability density distribution function for the i^{th} sector at a current grid point, respectively. The wind frequency Fᵢ of the i^{th} sector at the current grid point can be calculated by using the following equation (2):

$${\text{F}}_{\text{i}} = \frac{{\text{N}}_{\text{i}}}{\text{N}} \qquad \text{(2)}$$

where Nᵢ represents an amount of wind speed data of the i^{th} sector (wind direction), and N represents an amount of wind speed data of all sectors (all wind directions). Generally, the wind frequency Fᵢ of the i^{th} sector can be directly obtained from an inputted mesoscale wind atlas data file or other files.

In step S102, for each grid point, a weight of the annual average wind speed of each sector with respect to an annual average wind speed of all sectors is calculated based on the annual average wind speed of the sector and the wind frequency corresponding to the sector. In an embodiment, for the current grid point, a weight

$${\text{V}}_{\text{sector}}^{\text{i}}$$

of the annual average wind speed of the i^{th} sector with respect to the annual average wind speed of all the sectors can be calculated by using the following equation (3) based on the annual average wind speed

$${\text{V}}_{\text{ave}}^{\text{i}}$$

of the i^{th} sector and the wind frequency Fᵢ corresponding to the i^{th} sector:

$${\text{V}}_{\text{sector}}^{\text{i}} = {\text{V}}_{\text{ave}}^{\text{i}} \times {\text{F}}_{\text{i}} \qquad \text{(3)}$$

Then, in step S103, an annual average wind speed at each grid point is calculated based on the weight of the annual average wind speed of each sector with respect to the annual average wind speed of all the sectors. In an embodiment, an annual average wind speed V_{speed} (that is, annual average wind speed of all sectors (all wind directions)) at the current grid point can be obtained by adding up weights of the annual average wind speed at the current grid point on all the sectors (wind directions) by using the following equation (4):

$${\text{V}}_{\text{speed}} = {\sum }_{\text{i=1}}^{\text{N}} {\text{V}}_{\text{sector}}^{\text{i}} \qquad \text{(4)}$$

where N represents the number of the sectors.

In summary, based on the description with reference to FIG. 2, the annual average wind speed at each grid point in the inputted wind field area can finally be calculated.

In addition to the method for calculating the annual average wind speed V_{speed} at each grid point shown in FIG. 2, the following method for calculating the annual average wind speed at each grid point may also be used in the present disclosure.

In an embodiment, for a grid point, an annual average wind speed V_{speed} of the grid point can be expressed as:

$${\text{V}}_{\text{speed}} = {\int }_{0}^{∞} \text{vf} \left(\text{v}\right) \text{dv} \qquad \text{(5)}$$

where f() represents an annual Weilbull probability density distribution function at the current grid point without considering sectors, and f(v) represents a probability of occurrence of wind speed v at the current grid point, which can be expressed as:

$$\text{f} \left(\text{v}\right) = \frac{\text{k}}{\text{a}} {\left(\frac{\text{v}}{\text{a}}\right)}^{\text{k-1}} {\text{e}}^{\text{-} {\left(\frac{\text{v}}{\text{a}}\right)}^{\text{k}}} \qquad \text{(6)}$$

where a and k respectively represent a scale parameter and a shape parameter of the annual Weilbull probability density distribution function at the current grid point without considering sectors. The following equation can be derived from the above equations (5) and (6):

$${\text{V}}_{\text{speed}} = \text{a} \text{Γ} \left(1 + \frac{1}{\text{k}}\right) \qquad \text{(7)}$$

where Γ() represents gamma function. Thus, the annual average wind speed V_{speed} at each grid point can be calculated using the above equation (7) according to the present disclosure.

The two methods for calculating the annual average wind speed V_{speed} at each grid point have been described as above, but the present disclosure is not limited thereto. Any method for calculating the annual average wind speed at a grid point based on mesoscale wind atlas data can be used in present disclosure.

In addition, the performing a first screening on an inputted wind field area by using a wind speed limit to obtain a first wind field area further includes: removing grid points at which an annual average wind speed is less than the wind speed limit from the inputted wind field area to obtain the first wind field area.

In an embodiment, in order to optimize the inputted wind field area, the annual average wind speed at each grid point in the inputted wind field area may be compared with a preset wind speed limit (for example, 4.5 m/s), and the grid points at which the annual average wind speed is less than the wind speed limit is removed from the inputted wind field area, thereby obtaining a wind field area (that is, the first wind field area) on which wind speed optimization has been performed. The preset wind speed limit of 4.5 m/s is only exemplary, and the present disclosure is not limited thereto.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring back to FIG. 1, in step S200, based on inputted terrain data, a second screening is performed on the first wind field area by using a slope limit to obtain a second wind field area.

In practical application, considerations need to be given into terrain when setting up wind turbines, that is, considerations should be given into slopes. Since it is not easy to set up a wind turbine in an area having a large slope, a slope of each grid point in the first wind field area can be calculated based on inputted terrain data by using an elevation matrix, and then grid points having a slope greater than the slope limit can be removed from the first wind field area to obtain the second wind field area, that is, grid areas including the grid points having a slope greater than the slope limit is removed from the first wind field area to obtain the second wind field area. The process of calculating the slope of each grid point is described in detail hereinafter with reference to FIG. 3.

For a grid system corresponding to terrain data used in the embodiments of the present disclosure, a length and a width of a grid range from 10 m to 40 m.

As shown in FIG. 3, grids a, b, c, d, f, g, h, and i are around a central grid e and are adjacent to the central grid e. The slope depends on a rate of change (increment) of a surface in a horizontal direction (dz/dx) from the central grid e and a rate of change (increment) of the surface in a vertical direction (dz/dy) from the central grid e. The slope is usually measured in degrees. A slope D of the central grid e can be calculated by using the following equation (8):

$$\text{D= atan} \left(\text{sqrt} \left({\left[\text{dz} / \text{dx}\right]}^{\text{2}} \text{+} {\left[\text{dz} / \text{dy}\right]}^{\text{2}}\right)\right) \text{* 57} \text{.29578} \qquad \text{(8)}$$

where [dz/dx] represents a rate of change in x direction from the central grid e, and [dz/dy] represents a rate of change in y direction from the central grid e. [dz/dx] and [dz/dy] can be calculated by using the following equations (9) and (10):

$$\left[\text{dz} / \text{dx}\right] \text{=} \left(\left({\text{z}}_{\text{c}} {\text{+ 2z}}_{\text{f}} {\text{+ z}}_{i}\right) \text{-} \left({\text{z}}_{a} {\text{+ 2z}}_{d} {\text{+ z}}_{g}\right) / \left(8 * x \_ c e l l s i z e\right)\right) \qquad \text{(9)}$$

$$\left[\text{dz} / \text{dy}\right] \text{=} \left(\left({\text{z}}_{g} {\text{+ 2z}}_{h} {\text{+ z}}_{i}\right) \text{-} \left({\text{z}}_{a} {\text{+ 2z}}_{b} {\text{+ z}}_{c}\right)\right) / \left(8 * y \_ c e l l s i z e\right) \qquad \text{(10)}$$

where Zₐ, Z_{b}, Z_{c}, Z_{d}, Z_{f}, Z_{g}, Zₕ and Zᵢ respectively represent z coordinates of the grids a, b, c, d, f, g, h, and i, and x_cellsize and y_cellsize respectively represent dimensions of the grid in x and y directions.

In addition, if z value of a grid adjacent to the central grid e is NoData (that is, there is no data), z value of the central grid e is assigned to the grid adjacent to the central grid e. For example, if on the edge of a grid, z values of at least three grids (that is, grids outside the grid) are NoData, the z value of the central grid e is assigned to the at least three grids.

By using the above equations (8), (9), and (10), the slope of each grid in the first wind field area can be calculated. Since a grid point is a predetermined point in the grid (for example, one of four vertices), a slope of the grid point can be obtained accordingly, and then the grid points each having a slope greater than the slope limit can be removed from the first wind field area to obtain the second wind field area.

For example, the slope of each grid point in the first wind field area can be compared with a slope limit of 15 degrees, and grid points having a slope greater than 15 degrees can be removed from the first wind field area based on the comparison result, thereby realizing slope optimization on the wind field area (that is, the first wind field area) on which wind speed optimization has been performed with the wind speed limit, and obtaining the second wind field area. The slope limit of 15 degrees is only exemplary, and the present disclosure is not limited thereto.

Thereafter, as shown in FIG. 1, in step S300, a wind turbine arrangement that renders an objective function optimal is determined by using a method of taboo search having a target number of wind turbines and the second wind field area as inputs, wherein the objective function is a sum of annual power generations at wind turbine sites. The method may further include a step of validating the wind turbine arrangement by surveying suitable terrain and topography by a handhold surveying device, wherein the handhold surveying device has an antenna for receiving at least one wireless signal.

Accurate surveying for use in survey and Geographic Information System (GIS) applications requires relatively high accuracy GPS or other satellite positioning systems. To be assured of the accuracy required for these applications, it is known to use differential correction (DGPS) and RTK processes to increase the accuracy of a calculated position. Such systems require a GPS antenna and associated equipment, capable of receiving DGPS or RTK signals, typically housed in a back-pack worn by an operator due to the weight and/or size of the antenna and associated equipment.

Furthermore, known DGPS or RTK systems provide an accurate position only and do not allow or provide for the incorporation of additional data related to the calculated position. For example, known systems cannot readily incorporate chemical, physical, biological, geographical, geological, environmental, etc., data (such as soil color, soil type, vegetation type, geographic features, management features, etc.) related to the calculated position.

Presently, such additional data is normally collected by hand, for example by observation or by reading a display on a sampling device, and recorded on paper or in a separate computer, for subsequent processing in an office after the field work has been completed. The calculated positions and any manually obtained additional data must be subsequently combined and then analyzed. This can introduce the possibility of errors if calculated positions are not correctly mapped to the additional data. Moreover, analysis of data typically cannot begin until a person, such as a surveyor, has physically completed a field survey and returned to an office to provide the raw data, which can often introduce a delay of from a few days to several weeks or more.

Survey device generally may include at least one processor, or processing unit or plurality of processors, memory, at least one antenna and at least one output device, coupled together via a bus or group of buses. In certain embodiments, antenna and output device could be the same component and/or serve dual functions.

Survey device could be, wholly or in part, a type of processing system, computer or computerized device, mobile, cellular or satellite telephone, portable computer, tablet PC, Personal Digital Assistant (PDA), ‘smart phone’ or any other similar type of digital electronic device. The capability of such a device to request and/or receive information or data can be provided by software, hardware and/or firmware. Survey device may include or be associated with various other devices, for example a local data storage device such as a solid state drive.

At least one interface may also provide for coupling survey device to one or more peripheral devices, for example interface could provide for connection to a peripheral device via one or more types of cable, such as serial, parallel, optical, USB, etc., and/or via one or more types of wireless data transmission protocols, such as bluetooth, infrared, IEEE 802.11, etc. One or more peripheral devices (not illustrated) obtain environmental data which is input to survey device via interface . Survey device may receive environmental data either directly from the one or more peripheral devices via interface or by an operator inputting environmental data via interface when interface acts as a user/survey device interface.

Thus, interface may be an interface used by a human user of survey device. A user could manually input observed or measured environmental data using a user/survey device interface. For example, the user/survey device interface, which could be provided in conjunction with other types of interface as previously discussed, could be a keyboard, a pointing device such as a pen-like device, stylus or mouse, a touch screen for use with a stylus, and/or an audio receiving device for voice controlled activation such as a microphone.

A peripheral device can be one of many types of chemical, physical, biological, geographical, geological, environmental, etc., sampling devices. For example, environmental data collected by a peripheral device from a particular spatial position could include: soil color, soil type, vegetation type, geographic features, management features, etc. A wide variety of types of environmental data are possible and generally any type of sampling device could be interfaced with survey device.

Memory can be any form of memory device, for example, volatile or non-volatile memory, solid state storage devices, magnetic devices, etc. Processor could include more than one distinct processing device, which could for example handle different functions of survey device.

One or more antenna receive one or more spatial signals, which can include, for example: a GPS signal; a DGPS signal; a HP signal; a SDGPS signal; a RTK signal; either individually or in any combination; and/or any other type of wireless signal that facilitates determination of a spatial position of, or relative to, the antenna or associated equipment.

Output device sends or transmits collocated data (which may also be stored in memory) and can include for example: a data port; a USB port or any of the modes of data transmission as described for interface, a mobile or cellular telephone to transmit the collocated data, a data transmitter or further antenna, a modem or wireless network adaptor, etc.

For example, a mobile phone module can be provided to transmit collocated data via GSM, CDMA, 3G, etc. mobile phone networks, depending on available phone network coverage. A user could view collocated data output, or an interpretation of the data output on, for example, a display of the survey device, a remote monitor or using a printer. Output device could also be used to selectively or periodically store collocated data in a remote or local database.

In use, survey device receives spatial signal(s) via antenna(s) and processor(s) converts spatial signal(s) into spatial data which can be stored in memory. Memory could be dedicated processor memory and/or a more permanent data store, for example including a local database to store data. Interface allows wired and/or wireless communication between processor(s) and peripheral components that may serve a specialized purpose. Processor(s) receives environmental data via interface and environmental data can also be stored in memory. Processor(s) collocates spatial data, obtained from the spatial signal, and environmental data, either directly as received or from memory. Collocated data can be stored in memory (for subsequent retrieval) and/or transmitted to a remote computer system via output device. It should be appreciated that survey device may incorporate any form of computerized terminal, specialized hardware, or the like.

The following examples provide a more detailed discussion of particularly preferred embodiments. The examples are intended to be merely illustrative and not limiting to the scope of the present invention.

In a further particular embodiment, the survey device is a Differential Global Positioning System (DGPS) enabled, handheld data capture device, optionally encapsulated in a substantially water resistant protective casing. The survey device incorporates a microcomputer, or the like, which enables control of the DGPS, plus capture of spatial, and optionally time tagged, data that may be physically or remotely synchronized with a database. A GPS antenna incorporated within the survey device can be enabled to receive DGPS signals, which should give the survey device an accuracy of +/-100 mm. The survey device and associated software links the spatial data collected from the DGPS with environmental data related to characteristics of the sampled position. It is possible to attach or incorporate RTK enabled devices to allow capture of RTK signals which provide an accuracy of +/-10-50 mm. There is no requirement for additional equipment to be provided in a backpack, or other handheld attachments, however other equipment may be attached if required.

In a further particular embodiment, the handheld survey device includes: a water resistant protective outer casing; a microcomputer encompassing display; communications; operating software for data capture; data storage and system control; a miniature GPS antenna/receiver capable of receiving GPS, DGPS, HP; SDGPS and/or RTK signals; a miniaturized high performance power source that may have one or more voltage converters; a switching connection that allows switching between an external GPS, DGPS or RTK antenna/receiver or any spatial locating device of choice and an internal GPS, DGPS or RTK antenna; and, software that allows the synchronizing of data either by physical connection or a remote connection between the survey device and another computer, server or database. The microcomputer used could be a Personal Digital Assistant (PDA), smart phone, Tablet PC or some similar device.

Survey device is able to define a user’s position in northing-easting or latitude-longitude coordinates and additionally obtains an altitude measurement if required, thereby providing a data string that is representative of the position of survey device.

The data string defines the position of survey device in space in (y, x, z) coordinates. Survey device additionally provides for the attachment or combination of environmental data relating to various types of conditions or characteristics at or near position (y, x, z). Environmental data can be considered an additional data string (a1, a2, a3, ...).

Environmental data (a1, a2, a3 ...) can then be combined with spatial data (y, x, z) to obtain collocated data which could be stored in the form (y, x, z, a1, a2, a3, ...) or as permutations thereof, or in other possible combined forms such as a two dimensional array or higher order matrix. The environmental data could relate to either a three dimensional position (y, x, z) or a two dimensional position (y, x) on the earth’s surface. Survey device uses GPS, DGPS or RTK signals, or the like, received from GPS satellites and/or ground stations to calculate (y, x, z) coordinates.

In use, survey device is held by user, survey device being a handheld device, over a desired position ‘a’, preferably at a predetermined height. Once survey device is placed over the desired position, the data relating to that position can be collected. This data could relate to environmental conditions that prevail at that particular position. Once all required data is collected, the position can be logged and all data can be stored in memory, transmitted via output device, or if survey device is out of wireless communication range, subsequently transferred to a database. Memory, or additional separate memory in survey device, can provide a local database to store data.

Additional components of a survey device may be illustrated. Survey device includes a microcomputer connected to a GPS, DGPS or RTK antenna/receiver. More than one antenna can be provided including a miniature GPS antenna, a RTK antenna/receiver and an external GPS antenna. A GPS circuit board capable of receiving GPS, DGPS, SDGPS and RTK signals is provided. Power source is also provided which provides electrical power to GPS circuit board. The miniature GPS antenna, capable of receiving GPS, DGPS and SDGPS signals is fitted internally to device. Device is also capable of receiving GPS, DGPS and RTK signals from antenna or external antenna. To enable external antenna a Radio Frequency (RF) switch is provided and is used to alternate between external antenna and internal antenna. An optional RF amplifier is also provided to boost the signal strength between the antenna and GPS circuit board.

In a particular example embodiment the antenna may be a miniature device capable of receiving GPS, DGPS, SDGPS and HP signals. The miniature antenna contains a signal filter, a signal amplifier and associated circuitry fully enclosed within a ceramic outer casing. The antenna may be constructed from ceramic materials arranged in multiple layers and can be housed within the outer water proof casing of the device.

Power source may be any type of power supply device able to provide sufficient power and preferably be of dimensions suitable for use in a handheld device. If power source does not provide the correct voltage, then one or more voltage converters may be fitted to allow for correct power supply characteristics to various internal components of survey device.

Power source may be a miniaturized power pack capable of supplying power to each of the components of survey device, for example a rechargeable lithium ion battery pack, a lithium polymer battery pack, a micro-motor power pack, a miniature fuel cell power pack, a capacitor power pack, or any other suitable power source capable of supplying the required electrical power. Power source may incorporate more than one specific type of power source to provide power redundancy. This allows variable power supplies, such as photovoltaic cells, to be used. Preferably, power source, or at least one of the power sources constituting a combined power source with redundancy, is rechargeable and may be recharged using an appropriate charging device, or can be recharged using a motor vehicle’s battery. It is also possible to power survey device from an external power source.

It is also possible to attach and download data from other data collection or sampling devices via a variety of data transmission methods. Peripheral data collection or sampling devices may include data loggers, sensing equipment, keyboards, cameras, other GPS devices, etc. Data transmission methods could include serial or USB ports, or wireless transmission methods such as bluetooth, infrared, WiFi, etc.

In a particular example use, the peripheral sampling device may be a data logger connected to any external sampling device(s). The data loggers may include those manufactured by, for example: Campbell Scientific; Monitor Sensors; or Environ data. The external sampling devices could be used to measure, for example: ambient temperature; relative humidity; incoming solar radiation; wind speed and direction; rainfall; water depth; fluid flow rate; dissolved oxygen; etc. These sampling devices are generally used. to monitor environmental parameters such as weather, plant growth rates, water flow rates and water volume within particular water storages.

Microcomputer is provided with software applications that can be set for automatic shutdown if microcomputer remains idle for a predetermined period of time. Separate software can also allow survey device to be shut down and reset, for example using a display module of survey device as a user/device interface.

It is also possible to attach other physical locating devices such as a surveying tripod, a walking stick locater, a monopod device, etc., to further increase the accuracy of the spatial data collected.

Survey device, and an associated software application (i.e. computer program product) executable on microcomputer, allows an operator to capture spatially accurate data and combine the spatial data with environmental data relating to conditions or characteristics at a sampled position. The software application utilizes software job keys with a time expiry, which forces operators to synchronize survey device with a central database, which is not part of survey device. This synchronization is achieved by using a database synchronization software module and by connecting the microcomputer to a computer or server containing or in communication with central database. For example, the connection could be obtained by a physical connection, such as a cable, or via wireless data transmission means as previously described.

Survey device is additionally preferably provided with a mobile phone module. Thus, mobile phone module can be used to transmit data from microcomputer or memory to database when survey device is remote to database. This allows collocated data to be remotely transmitted to database whilst an operator continues to conduct surveys in the field.

Survey device can also be provided with a protective casing which is preferably substantially water resistant. Connection for external antenna can also be provided. Various connections can also be provided for connecting external collecting or sampling devices.

There is a method for operation of software provided in survey device. To initiate software, the software is selected at step from a startup menu available on the microcomputer. Once the software has been started the data is synchronized at step with database, either by physical connection or remote access. During the synchronization process, microcomputer receives a number of job keys from the database. These job keys, received at step, have a time expiry attached to them which preferably forces the user to synchronize with the central database prior to the job key’s expiry time. It is also possible to download predetermined sampling locations and information about the predetermined sampling locations including spatial data (y, x, z), together with conditions associated with that position (a1, a2, a3, ...) from the central database during the synchronization process. This is illustrated at step.

If the sampling location has been predetermined and is a known location then the position and/or the environmental data are located at step in the database. If there are no predetermined sampling locations as illustrated at step, the user can locate the desired sampling position and then log that particular position using the GPS module. Once the sampling position has been found, it is possible to then input the required environmental data that relates to that position. The data collected from a particular position could include, for example: soil color; soil type; vegetation type; geographic features; management features; or a wide variety of other types of information.

If survey device is within mobile phone coverage, it is then possible to upload the collected data to the central database, combined with the sampling position, and thereby synchronize data in microcomputer with the central database. This is illustrated at step. Alternately, if there is no mobile phone coverage or if the data is not required at the central database for a particular reason for some time, the data can be stored in memory to be synchronized with database at a later time. It is possible to synchronize the data with the central database either physically or remotely at any point in the future prior to a particular job key’s expiry date.

Once the synchronization has been completed, that particular job is identified as finished at step. If the microcomputer has more job keys sorted within the software, as can be checked, it is then possible to collect data relating to other sampling positions using the aforementioned procedure. If there are no more job keys available within the software, then microcomputer should be synchronized with central database prior to continuing. Once further job keys have been uploaded from the database or associated server, it is possible to continue onto other sampling locations.

A local database may be provided in survey device, associated with microcomputer, and can allow the capture and storage of both the spatial data and the environmental data that has been collected, and thus enables the user to synchronize this data with a larger central database. Once the data has been synchronized with the central database, reports can be generated concerning the spatial data (y, x, z) and the associated environmental data (a1, a2, a3, ...), together with the time of data collection which can be automatically logged and combined with or appended to collocated data sent to database. Thus, collocated data may be obtained in the form (i, y, x, z, a1, a2, a3, ...) where t is the time of sampling. The time of data collection could be obtained from a variety of sources such as an internal clock of microcomputer or via a signal received by an antenna of survey device.

In a particular non-limiting example, the software interface provided within the device is a VB.NET/C#.NETWindows compact framework application which interfaces with a SQL Server CE database for use on Windows CE platforms. The GPS operational software may be StorrnSource.GPS. In addition, OpenNETCF.Multimedia.Audio software can be provided within the survey device to run audio visual help files. Example pseudo code that can be used to enable the GPS satellites and begin receiving GPS signal is presented hereinafter.
GPS
Report Comm Status
OnGPSFix*Run when GPS makes a fix
OnSatellites*Report on satellites found
OnMovement*Run when GPS advises movement
OnGPSPort*Turns on and off GPS and Satellite display

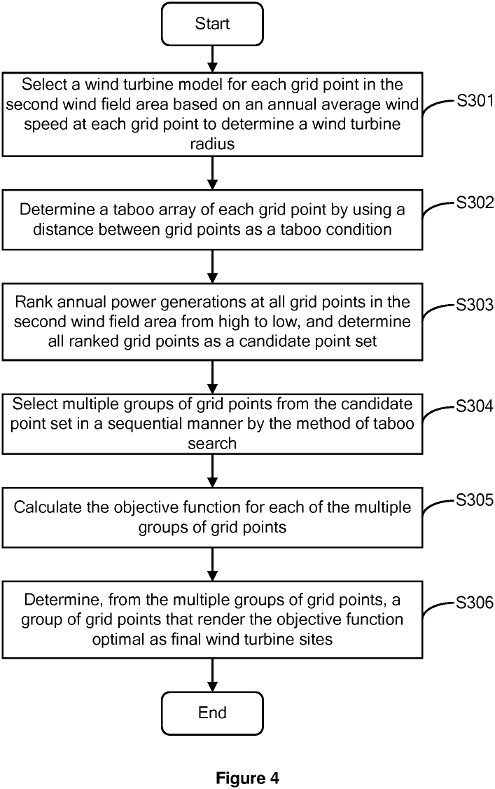

Detail descriptions are provided hereinafter with reference to FIG. 4. In the following description, for a grid system corresponding to a mesoscale atlas, a length and a width of each grid may range from 100 m to 200 m, and the present disclosure is not limited thereto.

Referring to FIG. 4, in step S301, for the second wind field area, a wind turbine model is selected for each grid point based on the annual average wind speed at each grid point to determine a wind turbine radius D.

In an embodiment, for the second wind field area obtained by the wind speed optimization and slope optimization, the wind turbine model is selected based on the annual average wind speed at each grid point first, and further, the wind turbine radius is determined based on the selected wind turbine model. For example, if an annual average wind speed at a grid point is 5.0 m/s, a wind turbine model of GW121-2000 may be selected, and since the wind turbine model has been determined for the grid point, the wind turbine radius D can be determined.

Then, in step S302, a distance between grid points is used as a taboo condition to determine a taboo array of each grid point.

In an embodiment, after the wind turbine radius D is determined, a distance between grid points can be used as a taboo condition to determine a taboo array of each grid point based on a 3D principle (that is, 3 times the wind turbine radius). In an embodiment, assuming that the 3D principle is adopted, if a distance between a grid point A and a grid point B is less than 3D, the grid point B is added to a taboo array of the grid point A, and if the distance between the grid point A and the grid point B is greater than or equal to 3D, the grid point B is not added to the taboo array of the grid point A. The grid points in the second wind field area are traversed in this way to determine the taboo array of the grid point A. Similarly, a taboo array of each of all grid points in the second wind field area can be determined according to the above process. In addition, while the process of determining the taboo array of each grid point based on the 3D principle is described above, it is only an exemplary embodiment, and the present disclosure is not limited thereto. The taboo array of each grid point may also be determined based on similar principles such as a 5D principle.

In step S303, based on the annual power generation at each grid point in the second wind field area, annual power generations at all grid points in the second wind field area are ranked from high to low, and all the ranked grid points are determined as a candidate point set.

Although not shown in FIG. 4, it can be understood that before step S303, the annual power generation at each grid point in the second wind field area may be calculated based on the annual average wind speed at the grid point in the second wind field area.

In an embodiment, after the annual average wind speed at each grid point is calculated, the annual average wind speed V_{speed} at the grid point is divided into n wind speed intervals with an interval of 1 m/s (for example, 0 to 1 m/s, 1 to 2 m/s, ..., 18 to 19 m/s, ...), and an annual power generation E of a single wind turbine at each grid point may be calculated by using the following equation (11) with reference to a power curve function:

$$\text{E} = {\sum }_{\text{i=1}}^{\text{n}} \text{P} \left({\text{v}}_{\text{i}}\right) {\text{T}}_{\text{i}} \qquad \text{(11)}$$

where vᵢ represents an i^{th} interval, P(vᵢ) represents a pre-given wind turbine power curve, and Tᵢ represents the number of hours of an annual power generation for the i^{th} wind speed interval and is determined by the following equation (12) with the Weilbull cumulative probability distribution function F(vᵢ) at the corresponding grid point and the fact that a total number Tₜ of hours in a year is equal to 8760:

$${\text{T}}_{\text{i}} \text{=} \left[\text{F} \left({\text{v}}_{\text{i}} \text{+0} \text{.5}\right) \text{-F} \left({\text{v}}_{\text{i}} \text{-0} \text{.5}\right)\right] {\text{T}}_{\text{t}} \qquad \text{(12)}$$

where F(vᵢ+0.5) and F(vᵢ-0.5) are both Weilbull cumulative probability distribution functions and respectively represent a probability of a wind speed being between 0 and (vᵢ+0.5) and a probability of a wind speed being between 0 and (vᵢ-0.5), which are given in the following equations (13) and (14):

$$\text{F} \left({\text{v}}_{\text{i}} + 0.5\right) = 1 - {\text{e}}^{- {\left(\frac{\left({\text{v}}_{\text{i}} + 0.5\right)}{\text{a}}\right)}^{\text{k}}} \qquad \text{(13)}$$

$$\text{F} \left({\text{v}}_{\text{i}} - 0.5\right) = 1 - {\text{e}}^{- {\left(\frac{\left({\text{v}}_{\text{i}} - 0.5\right)}{\text{a}}\right)}^{\text{k}}} \qquad \text{(14)}$$

In summary, the annual power generation at each grid point can be calculated by the above equations (11) to (14). Thus, all grid points in the second wind field area can be ranked in a descending order by the annual power generations at the grid points, and all the ranked grid points are determined as a candidate point set P, where the number of the grid points in the candidate point set P is much larger than the target number of wind turbines.

In step S304, by the method of taboo search, multiple groups of grid points are selected from the candidate point set P in a sequential manner, where each of the multiple groups of grid points includes at least one grid point meeting the taboo condition. The number of the at least one grid point is equal to the target number of wind turbines.

In an embodiment, when selecting a first group of grid points, the at least one grid point meeting the taboo condition is selected from the candidate point set P by the method of taboo search. The specific process is as follows. First, a first grid point ranked at the first position in the candidate point set P is selected. Then a second grid point is selected from the candidate point set P in order of the annual power generations at the grid points from high to low, and it is determined whether the second grid point is in a taboo array of any one of all preceding grid points (that is, the first grid point). If the second grid point is not in a taboo array of any one of all the preceding grid points (that is, the first grid point), the second grid point is selected as a second member of the first group of grid points; otherwise, the second grid point is not selected as a member of the first group of grid points. Then, it is determined whether a next grid point (that is, a third grid point) in the candidate point set P is in a taboo array of any one of all preceding grid points (that is, the first grid point and the second grid point). Continuing in this way, when determining an i^{th} grid point of the at least one grid point in the first group of grid points, it is determined whether a grid point selected from the candidate point set P in order of the annual power generations from high to low is in a taboo array of any one of all preceding grid points (that is, all the grid points in the candidate point set P before the currently selected grid point). If the selected grid point is not in a taboo array of any one of all the preceding grid points, the grid point selected from the candidate point set P is selected as an i^{th} member of the first group of grid points; otherwise, the grid point selected from the candidate point set P is not selected as the i^{th} member of the first group of grid points. The above process is repeated until the selection of the at least one grid point in the first group of grid points is completed.

Then, when selecting a j^{th} group of grid points, the at least one grid point meeting the taboo condition is selected from the candidate point set P by the method of taboo search, where j is an integer greater than 1. The specific process is as follows. First, a j^{th} grid point ranked at the j^{th} position in the candidate point set P is selected in order of the annual power generations at the grid points from high to low, and the j^{th} grid point is determined as a first member of the j^{th} group of grid points. Then, a next grid point (that is, a (j+1)^{th} grid point) is selected from the candidate point set P in order of the annual power generations at the grid points from high to low, and it is determined whether the next grid point is in a taboo array of any one of all preceding grid points before the next grid point in the candidate point set P. If the next grid point is in a taboo array of any one of all the preceding grid points, the next grid point is not selected as a member of the j^{th} group of grid points; otherwise, the next grid point is selected as a member of the j^{th}group of grid points. The above process is repeated until the selection of the at least one grid point in the j^{th} group of grid points is completed.

In this way, the multiple groups of grid points can be selected from the candidate point set P, where each of the multiple groups of grid points includes at least one grid point meeting the taboo condition. The number of the grid points in the candidate point set P is much larger than the target number of wind turbines; therefore, when selecting the multiple groups of grid points, in order to avoid a waste of computing resources due to traversing all the grid points in the candidate point set P, the process of selecting the multiple groups of grid points from the candidate point set P is terminated when recursion is performed to, for example, only one-half of the candidate point set P, without traversing all the grid points. However, this is only an example, and the present disclosure is not limited thereto. For example, when selecting the multiple groups of grid points, recursion can be performed to, one-third or two-thirds of the candidate point set P.

Then, in step S305, the objective function is calculated for each of the multiple groups of grid points.

In an embodiment, a sum of the annual power generation of the at least one grid point (that is, wind turbine sites) in each group of grid points is determined as the objective function according to the present disclosure. That is, a sum of annual power generations is calculated for each group of the multiple groups of grid points.

Then, in step S306, a group of grid points that render the objective function optimal are selected from the multiple groups of grid points and determined as final wind turbine sites. In an embodiment, in the method, a group of grid points with the largest sum of annual power generations in the multiple groups of grid points is determined as the final wind turbine sites. In this way, the final wind turbine sites, that is, position coordinates of wind turbines, are determined.

For example, Table 1 below shows optimal wind turbine arrangement solutions, which are obtained by processing the inputted wind field area based on the inputted mesoscale wind atlas data and terrain data, under the condition that the target number of wind turbines is 25, the wind speed limit is 4.5 m/s and the slope limit is 15 degrees. A total of 8 wind turbine arrangement solutions are listed in order of excellence from top to bottom in Table 1. Each wind turbine arrangement solution includes information of 25 wind turbine sites. The total annual power generations (in kilowatt-hour (kW.h)) for the 25 wind turbine sites are listed in the rightmost column. For each wind turbine arrangement solution, only values of four specific wind turbine sites in the 25 wind turbine sites are shown in Table 1. The information of a wind turbine is X and Y coordinates (in meter (m)) in WGS-84 coordinate system.

TABLE 1

| | Wind turbine site 1 | Wind turbine site 2 | Wind turbine site 3 | ... | Wind turbine site 25 | Total annual power generation |
|---|---|---|---|---|---|---|
| Solution 1 | X=4386178, Y=3836488 0 | X=4402378, Y=3836476 0 | X=4401898, Y=3836692 0 | ... | X=38378880, Y=4386618 | 169876401.941 |
| Solution 2 | X=38363840, Y=4402658 | X=3837804 0, Y=4385458 | X=3837764 0,Y=43857 78 | ... | X=38378880, Y=4386618 | 169870715.064 |
| Solution 3 | X=38363880, Y=4402658 | X=3837804 0,Y=43854 58 | X=3837764 0,Y=43857 78 | ... | X=38378880, Y=4386618 | 169716588.998 |
| Solution 4 | X=38363800, Y=4402658 | X=3837804 0,Y=43854 58 | X=3837764 0,Y=43857 78 | ... | X=38378880, Y=4386618 | 169711802.007 |
| Solution 5 | X=3836436 0, Y=4402618 | X=3837804 0, Y=4385458 | X=3837764 0, Y=4385778 | ... | X=3837888 0, Y=4386618 | 169701852.999 |
| Solution 6 | X=3836428 0, Y=4402658 | X=3837804 0, Y=4385458 | X=3837764 0, Y=4385778 | ... | X=3837888 0, Y=4386618 | 169699062.307 |
| Solution 7 | X=3836376 0, Y=4402658 | X=3837804 0, Y=4385458 | X=3837764 0, Y=4385778 | ... | X=3837888 0, Y=4386618 | 169694519.850 |
| Solution 8 | X=3837892 0, Y=4385858 | X=3837804 0, Y=4385458 | X=3837764 0, Y=4385778 | | X=3837888 0, Y=4386658 | 169559461.373 |

With the method described above, the arrangement of wind turbines can be finally determined, that is, the site information, annual power generation, and model of each wind turbine can be finally determined.

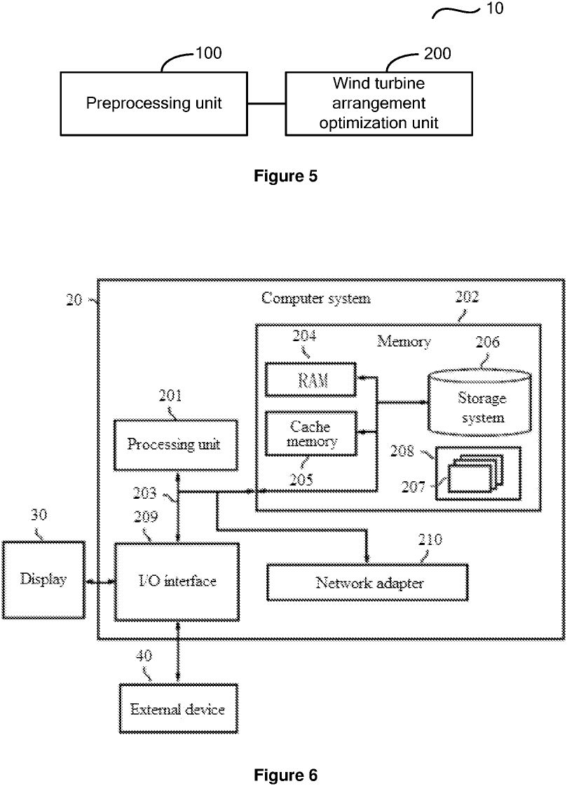

FIG. 5 is a block diagram of a device 10 for automatically arranging a wind turbine based on mesoscale data according to an exemplary embodiment of the present disclosure.

Referring to FIG. 5, the device 10 includes a preprocessing unit 100 and a wind turbine arrangement optimization unit 200.

The preprocessing unit 100 may be configured to perform, based on inputted mesoscale wind atlas data, a first screening on an inputted wind field area by using a wind speed limit to obtain a first wind field area. The mesoscale wind atlas data is wind resource distribution data which is calculated by using a mesoscale numerical model. In an embodiment, the mesoscale wind atlas data is data of wind resources with typical grid precision at mesoscale level, which is calculated by using the mesoscale numerical model combined with wind measurement data. The mesoscale wind atlas data may include a shape parameter (k) and a scale parameter (a) of an annual Weilbull probability density distribution function for each sector (that is, each wind direction) of each grid point. Or, the mesoscale wind atlas data may include a shape parameter (k) and a scale parameter (a) of an annual Weilbull probability density distribution function at each grid point.

In an embodiment, when performing the first screening on the inputted wind field area, the preprocessing unit 100 may first calculate an annual average wind speed at each grid point in the inputted wind field area based on the inputted mesoscale wind atlas data.

In an embodiment, when calculating the annual average wind speed at each grid point, the preprocessing unit 100 may first obtain, for each grid point, an annual average wind speed of each sector and a wind frequency corresponding to each sector based on the inputted mesoscale wind atlas data, that is, obtaining the annual average wind speed of each sector and the wind frequency corresponding to each sector by the above equations (1) and (2). Since detailed descriptions have been provided as above, the process is not described repeatedly here.

Then, the preprocessing unit 100 may calculate, for each grid point, a weight of the annual average wind speed of each sector with respect to an annual average wind speed of all sectors based on the annual average wind speed of the sector and the wind frequency corresponding to the sector, and calculate the annual average wind speed at each grid point based on the weight of the annual average wind speed of each sector with respect to the annual average wind speed of all the sectors, where the sector indicates a wind direction. In an embodiment, the wind speed of each sector can be calculated by using the above equation (3), and the annual average wind speed at each grid point can be calculated by using the equation (4).

In addition, the preprocessing unit 100 may further calculate the annual average wind speed at each grid point by using the above equation (7).

Since the process of calculating the annual average wind speed at each grid point has been described in detail, it is not repeated here.

After calculating the annual average wind speed at each grid point, the preprocessing unit 100 may remove grid points at which the annual average wind speed is less than the wind speed limit from the inputted wind field area to obtain the first wind field area. For example, the preprocessing unit 100 may compare the annual average wind speed at each grid point in the inputted wind field area with a preset wind speed limit (for example, 4.5 m/s), and remove grid points at which the annual average wind speed is less than the wind speed limit from the inputted wind field area to obtain a preliminary screened wind field area (that is, the first wind field area).

In addition, the preprocessing unit 100 may perform, based on inputted terrain data, a second screening on the first wind field area by using a slope limit to obtain a second wind field area.

In practical application, considerations need to be given into terrain (that is, considerations should be given into slopes) when setting up wind turbines, as it is not easy to set up a wind turbine in an area having a large slope. Therefore, after the first screening is performed on the inputted wind field area to obtain the first wind field area, the second screening is required on the first wind field area to remove grid points having an excessive slope to obtain the second wind field area. In an embodiment, the preprocessing unit 100 may calculate a slope of each grid point in the first wind field area based on the inputted terrain data by using an elevation matrix, and remove grid points having a slope greater than the slope limit from the first wind field area to obtain the second wind field area. Since detailed descriptions have been provided above with reference to FIG. 3, the process is not described repeatedly here.

After the preprocessing unit 100 performs the first and the second screening on the inputted wind field area, the wind turbine arrangement optimization unit 200 may determine a wind turbine arrangement that renders an objective function optimal by using a method of taboo search having a target number of wind turbines and the second wind field area as inputs, where the objective function is a sum of annual power generations at wind turbine sites.

In an embodiment, the wind turbine arrangement optimization unit 200 may select a wind turbine model for each grid point based on the annual average wind speed at each grid point in the second wind field area to determine a wind turbine radius. For example, if an annual average wind speed at a grid point is 5.0 m/s, a wind turbine model of GW121-2000 may be selected by the wind turbine arrangement optimization unit 200 based the annual average wind speed at the grid point, and since the wind turbine model has been determined for the grid point, a wind turbine radius D can be determined by the wind turbine arrangement optimization unit 200.

The wind turbine arrangement optimization unit 200 may use a distance between grid points as a taboo condition to determine a taboo array of each grid point. In an embodiment, after the wind turbine radius D is determined, the wind turbine arrangement optimization unit 200 may use a distance between grid point as a taboo condition to determine a taboo array of each grid point based on a 3D principle (that is, 3 times the wind turbine radius). In an embodiment, assuming that the 3D principle is adopted, if a distance between a grid point A and a grid point B is less than 3D, the grid point B is added to a taboo array of the grid point A by the wind turbine arrangement optimization unit 200; otherwise, the grid point B is not added to the taboo array of the grid point A by the wind turbine arrangement optimization unit 200. Thus, the grid points in the pre-processed wind field area are traversed by the wind turbine arrangement optimization unit 200 in this way to determine the taboo array of the grid point A. Similarly, a taboo array of each of all grid points in the second wind field area can be determined by the wind turbine arrangement optimization unit 200 according to the above process. In addition, while the process of determining a taboo array of each grid point based on the 3D principle is described above, it is only an exemplary embodiment, and the present disclosure is not limited thereto. The taboo array of each grid point in the second wind field area may also be determined by the wind turbine arrangement optimization unit 200 based on similar principles such as a 5D principle.

In addition, the wind turbine arrangement optimization unit 200 may further calculate an annual power generation at each grid point in the second wind field area based on the annual average wind speed at the grid point in the second wind field area. In an embodiment, the wind turbine arrangement optimization unit 200 may calculate the annual power generation at each grid point in the second wind field area by using the above equations (11) to (14). Since detailed descriptions have been provided above, the process is not described repeatedly here.

In addition, the wind turbine arrangement optimization unit 200 may rank annual power generations at all grid points in the second wind field area from high to low based on the annual power generation at each grid point in the second wind field area, and determine all ranked grid points as a candidate point set. Before ranking all the grid points in the second wind field area, the wind turbine arrangement optimization unit 200 may calculate the annual power generation at each grid point in the second wind field area. That is, since the annual power generation at each grid point has been calculated by using the equations (11) to (14), the wind turbine arrangement optimization unit 200 may rank all the grid points in the second wind field area by the annual power generations at the grid points from high to low, and then determine all ranked grid points as a candidate point set.

Thereafter, the wind turbine arrangement optimization unit 200 may select multiple groups of grid points from the candidate point set in a sequential manner, where each of the multiple groups of grid points includes at least one grid point meeting the taboo condition and the number of the at least one grid point is equal to the target number of wind turbines. Since detail descriptions have been provided above, the process is not described repeatedly here.

After selecting the multiple groups of grid points, the wind turbine arrangement optimization unit 200 may calculate the objective function for each of the multiple groups of grid points.

In an embodiment, a sum of the annual power generation at the at least one grid point (that is, a site of the wind turbine) in each group of grid points is determined as the objective function according to the present disclosure. That is, the wind turbine arrangement optimization unit 200 may calculate a sum of annual power generations for each group of the multiple groups of grid points.

Thereafter, the wind turbine arrangement optimization unit 200 selects, from the multiple groups of grid points, a group of grid points that render the objective function optimal and determines the selected group of grid points as final wind turbine sites. In an embodiment, the wind turbine arrangement optimization unit 200 determines a group of grid points with the largest sum of annual power generations in the multiple groups of grid points as the final wind turbine sites. In this way, the final wind turbine sites, that is, position coordinates of wind turbines, are determined.

According to the process described above, the arrangement of wind turbines can be finally determined by the device 10, that is, the site information, annual power generation, and model of each wind turbine can be finally determined.

FIG. 6 is a block diagram of an exemplary computer system 20 suitable for implementing the exemplary embodiments of the present disclosure. The computer system 20 shown in FIG. 6 is only exemplary, and shall not limit the functions and scope of the embodiments of the present disclosure.

As shown in FIG. 6, the computer system 20 may be implemented in the form of a general-purpose computing device. Components of the computer system 20 may include, but are not limited to, one or more processors or processing unit 201, a system memory 202, and a bus 203 for connecting different system components (including the system memory 202 and the processing unit 201).

The bus 203 represents one or more of various bus structures. For example, these bus structures include, but are not limited to: an industry standard architecture (ISA) bus, a micro channel architecture (MAC) bus, an enhanced ISA bus, a video electronics standards association (VESA) local bus, and a peripheral component interconnect (PCI) bus.

The computer system 20 typically includes a variety of computer system-readable media. These media may be any available media that can be accessed by the computer system 20, including volatile and non-volatile media, and removable or non-removable media.

The system memory 202 may include computer system-readable media in a form of volatile memory, such as a random access memory (RAM) 204 and/or a cache memory 205. The computer system 20 may further include other removable/non-removable, volatile/non-volatile computer system storage media. For example only, a storage system 206 may be used to read and write non-removable, non-volatile magnetic media (which is not shown in FIG. 6 and is commonly referred to as a “hard drive”). Although not shown in FIG. 6, a disk drive for reading and writing of a removable non-volatile disk (such as a floppy disk) and an optical disc drive for reading and writing of a removable non-volatile optical disc (such as a CD-ROM, DVD-ROM, or other optical media) may be provided. In these cases, each drive may be connected to the bus 203 by one or more data medium interfaces. The system memory 202 may include at least one program product, where the program product has at least one program module 207 configured to perform multiple functions according to the embodiments of the present disclosure.

A program/utility tool 208 having the at least one program module 207 may be stored in, for example, the system memory 202. The program module 207 includes, but is not limited to: an operating system, one or more application programs, other program modules, and program data. In addition, each of or some combination of the examples may include an implementation of a network environment. The program module 207 is generally configured to perform functions and/or methods according to the embodiments of the present disclosure.

The computer system 20 may also communicate with a display 30 and one or more other external devices 40 (such as a keyboard, and a pointing device), and may also communicate with one or more devices that enable a user to interact with the computer system 20, and/or may communicate with any device (such as a network card, and a modem) that enables the computer system 20 to communicate with one or more other computing devices. The communication may be performed via an input/output (I/O) interface 209. In addition, the computer system 20 may also communicate with one or more networks (such as a local area network (LAN), a wide area network (WAN), and/or a public network (such as the Internet)) via a network adapter 210. As shown in FIG. 6, the network adapter 210 may communicate with other modules of the computer system 20 through the bus 203. It should be understood that although not shown in FIG. 6, other hardware and/or software modules may be used in conjunction with the computer system 20, including but not limited to: microcode, device drivers, redundant processing units, external disk drive arrays, RAID systems, tape drives, and data backup storage systems.

It should be noted that FIG. 6 only schematically shows a diagram of a computing system for implementing the embodiments of the present disclosure. It can be understood by those skilled in the art that the computer system 20 can be implemented by an existing computing device in a conventional wind turbine, or can be implemented by introducing an additional computing device, or can be implemented by the existing computing device in the wind turbine and the newly introduced device combined.

Furthermore, a computer readable storage medium with a program stored thereon is provided according to the present disclosure. The program includes instructions for performing operations in the method for automatically arranging a wind turbine based on mesoscale data. In an embodiment, the program may include instructions for performing the steps shown in FIGS. 1, 2, and 4.

Furthermore, a computer is provided according to the present disclosure. The computer includes a readable medium with a computer program stored thereon, where the program includes instructions for performing operations in the method for automatically arranging a wind turbine based on mesoscale data. In an embodiment, the program may include instructions for performing the steps shown in FIGS. 1, 2, and 4.

With the above method and device for automatically arranging a wind turbine based on mesoscale data, automatically arranging wind turbines in an inputted wind field area based on inputted mesoscale wind atlas data can be realized. With the above method and device, an optimized global automatic arrangement of wind turbines is achieved in the macro-siting stage, the amount of data used for the wind turbine automatic arrangement optimization can be effectively reduced, accuracy can be improved and risky areas can be avoided, thereby achieving quick response to service demands and instantly generating wind turbine arrangement solutions to effectively support technical applications.

The above embodiments of the present disclosure are only exemplary, and shall not be deemed as limiting the present disclosure. Those skilled in the art should understand that changes can be made to the embodiments without departing from the principle and spirit of the present disclosure, where the scope of the present disclosure is defined by the claims and their equivalents.

1. A method, comprising:
performing, based on inputted mesoscale wind atlas data, a first screening on an inputted wind field area by using a wind speed limit to obtain a first wind field area;
performing, based on an inputted terrain data, a second screening on the first wind field area by using a slope limit to obtain a second wind field area;
determining, by using a method of taboo search having a target number of wind turbines and the second wind field area as inputs, a wind turbine arrangement that renders an objective function optimal; and
validating the wind turbine arrangement by surveying suitable terrain and topography by a handhold surveying device, wherein the handhold surveying device has an antenna for receiving at least one wireless signal,
wherein the objective function is a sum of annual power generations at wind turbine sites.

2. The method according to claim 1, wherein the performing a first screening on an inputted wind field area by using a wind speed limit to obtain a first wind field area comprises:
calculating an annual average wind speed at each grid point in the inputted wind field area based on the inputted mesoscale wind atlas data; and
removing grid points at which an annual average wind speed is less than the wind speed limit from the inputted wind field area to obtain the first wind field area.

3. The method according to claim 2, wherein the calculating an annual average wind speed at each grid point based on the inputted mesoscale wind atlas data comprises:
obtaining, for each grid point, an annual average wind speed of each sector and a wind frequency corresponding to each sector based on the inputted mesoscale wind atlas data;
calculating, for each grid point, a weight of the annual average wind speed of each sector with respect to an annual average wind speed of all sectors based on the annual average wind speed of the sector and the wind frequency corresponding to the sector; and
calculating the annual average wind speed at each grid point based on the weight of the annual average wind speed of each sector with respect to the annual average wind speed of all the sectors,
wherein the sector indicates a wind direction.

4. The method according to claim 1, wherein the performing a second screening on the first wind field area by using a slope limit to obtain a second wind field area comprises:
calculating a slope of each grid point in the first wind field area based on an elevation matrix; and
removing grid points having a slope greater than the slope limit from the first wind field area to obtain the second wind field area.

5. The method according to claim 1, wherein the determining a wind turbine arrangement that renders an objective function optimal comprises:
selecting a wind turbine model for each grid point in the second wind field area based on an annual average wind speed at each grid point to determine a wind turbine radius;
determining a taboo array of each grid point by using a distance between grid points as a taboo condition;
ranking, based on an annual power generation at each grid point in the second wind field area, annual power generations at all grid points in the second wind field area from high to low, and determining all ranked grid points as a candidate point set;
selecting a plurality of groups of grid points from the candidate point set in a sequential manner by the method of taboo search, wherein each of the plurality of groups of grid points comprise at least one grid point meeting the taboo condition;
calculating the objective function for each of the plurality of groups of grid points; and
determining, from the plurality of groups of grid points, a group of grid points that render the objective function optimal as final wind turbine sites.

6. The method according to claim 5, further comprising:
calculating the annual power generation at each grid point based on the annual average wind speed at the grid point in the second wind field area.

7. A method, comprising:
obtaining, for each grid point, an annual average wind speed of each sector and a wind frequency corresponding to each sector based on an inputted mesoscale wind atlas data to perform a first screening on an inputted wind field area by using a wind speed limit to obtain a first wind field area;
performing, based on an inputted terrain data, a second screening on the first wind field area by using a slope limit to obtain a second wind field area;
determining, by using a method of taboo search having a target number of wind turbines and the second wind field area as inputs, a wind turbine arrangement that renders an objective function optimal; and
validating the wind turbine arrangement by surveying suitable terrain and topography by a handhold surveying device, wherein the handhold surveying device has an antenna for receiving at least one wireless signal.

8. The device according to claim 7, wherein the performing a first screening on an inputted wind field area by using a wind speed limit to obtain a first wind field area comprises:
calculating, for each grid point, a weight of the annual average wind speed of each sector with respect to an annual average wind speed of all sectors based on the annual average wind speed of the sector and the wind frequency corresponding to the sector.

9. The method according to claim 8, wherein the performing a first screening on an inputted wind field area by using a wind speed limit to obtain a first wind field area further comprises:
calculating the annual average wind speed at each grid point based on the weight of the annual average wind speed of each sector with respect to the annual average wind speed of all the sectors,
wherein the sector indicates a wind direction.

10. The method according to claim 7, wherein in performing the second screening on the first wind field area comprises: calculating a slope of each grid point in the first wind field area based on an elevation matrix, and removing grid points having a slope greater than the slope limit from the first wind field area to obtain the second wind field area.

11. The method according to claim 7, wherein the determining a wind turbine arrangement that renders the objective function optimal comprising:
selecting a wind turbine model for each grid point in the second wind field area based on an annual average wind speed at each grid point to determine a wind turbine radius.

12. The method according to claim 11, wherein the determining a wind turbine arrangement that renders the objective function optimal further comprising:
determining a taboo array of each grid point by using a distance between grid points as a taboo condition.

13. The method according to claim 12, wherein the determining a wind turbine arrangement that renders the objective function optimal further comprising:
ranking, based on an annual power generation at each grid point in the second wind field area, annual power generations at all grid points in the second wind field area from high to low, and determining all ranked grid points as a candidate point set.

14. The method according to claim 13, wherein the determining a wind turbine arrangement that renders the objective function optimal further comprising:
selecting a plurality of groups of grid points from the candidate point set in a sequential manner by the method of taboo search, wherein each of the plurality of groups of grid points comprise at least one grid point meeting the taboo condition.

15. The method according to claim 14, wherein the determining a wind turbine arrangement that renders the objective function optimal further comprising:
calculating the objective function for each of the plurality of groups of grid points; and
determining, from the plurality of groups of grid points, a group of grid points that render the objective function optimal as final wind turbine sites.

16. A method, comprising:
a first screening on an inputted wind field area by using a wind speed limit to obtain a first wind field area;
a second screening on the first wind field area by using a slope limit to obtain a second wind field area;
determining a wind turbine arrangement that renders an objective function optimal; and
validating the wind turbine arrangement by surveying suitable terrain and topography by a handhold surveying device, wherein the handhold surveying device has an antenna for receiving at least one wireless signal.

17. The method of claim 16, wherein the first screening on an inputted wind field area by using a wind speed limit to obtain a first wind field area is based on inputted mesoscale wind atlas data.

18. The method of claim 16, wherein the second screening the second screening on the first wind field area by using a slope limit to obtain a second wind field are is based on inputted mesoscale atlas data.

19. The method of claim 16, wherein the determining a wind turbine arrangement that renders an objective function optimal uses a taboo search having a target number of wind turbines and the second wind field area as inputs.

20. The method of claim 16, wherein the objective function is a sum of annual power generations at wind turbine sites.
